(19) United States
(12) Patent Application Publication
(10) Pub. No.: US 2003/0104156 A1
(43) Pub. Date: Jun. 5, 2003

(54) Composite material

(76) Inventors: Tamotsu Osada, Tokyo-To (JP); Takayuki Kamiyama, Tokyo-To (JP)

Correspondence Address: SMITH, GAMBRELL & RUSSELL, LLP, 1850 M STREET, N.W., SUITE 800, WASHINGTON, DC, 20036, US

(21) Appl. No.: 10/305,398

(22) Filed: Nov. 27, 2002

(30) Foreign Application Priority Data
Nov. 30, 2001 (JP) 2001-366742

(51) Int. Cl. B32B 9/00

(52) U.S. Cl. 428/40.1

(57) ABSTRACT

A composite material, which can be used as an alternative material to a prepreg, comprises a dry substrate fabric sheet, and at least thermosetting resin thin film is attached to one of the surface of the substrate fabric sheet. The substrate fabric sheet is thick and a multi-axial laminate structure formed by laying up a plurality of aligned fiber plies, and is not impregnated with resin previously.

### BACKGROUND OF THE INVENTION

1. Field of the Invention

The present invention relates to a composite material and, more particularly, to a composite material that can be used as an alternative material to a prepreg.

2. Description of the Related Art

In recent years, various composite materials formed of fiber-reinforced plastics have been proposed and applied to practical uses to meet needs for weight reduction and strength enhancement. For example, in the aerospace industry, prepreg, i.e., a sheet of composite material formed by impregnating the substrate fabric with a thermosetting matrix resin and partially curing it, is used. Composite products such as the skin panel of aircraft wings are formed by cutting a prepreg sheet into a predetermined shape, laminating the cut prepreg sheets on a mold, and applying heat and pressure to the laminated prepreg sheets in an autoclave.

However, as the prepreg is a thin material, a number of prepreg sheets must be laminated to form composite products such as the aircraft wing, which requires much time and labor.

Since the prepreg sheet is formed by impregnating a substrate fabric with a matrix resin, sometimes air trapped between the layers of the laminated prepregs cannot be satisfactorily removed. Therefore, air trapped between the layers of the laminated prepregs must be removed by applying pressure to the laminated prepregs in an autoclave or the like to produce a composite material of a satisfactory quality and to prevent strength reduction.

For manufacturing a prepreg sheet, there are two methods of a hot-melt method and a solution method. In the hot-melt method, a substrate fabric for strength enhancement is sandwiched between a pair of thermosetting resin films to form a laminated structure, and heat and pressure are applied to the laminated structure to impregnate the substrate fabric with the molten thermosetting resin. On the other hand, in the solution method, a substrate fabric for strength enhancement is immersed into a solution containing thermosetting resin solved with a solvent, then the substrate fabric is dried to remove the solvent and to impregnate it with the thermosetting resin.

If a relatively thick prepreg sheet can be manufactured with these methods, time and labor for laminating a number of prepregs can be reduced. However, these methods cause the following problems in manufacturing a comparatively thick prepreg. That is, hot-melt method is unable to satisfactorily impregnate an interior part of a thick substrate fabric. And, the solution method is unable to satisfactorily volatilize the solvent of the solution impregnated into an interior part of the thick substrate fabric. Consequently, the relatively thick prepreg sheet manufactured with above mentioned conventional methods cannot have the functions of a composite material and cannot form composite products having a satisfactory quality.

### SUMMARY OF THE INVENTION

Accordingly, it is an object of the present invention to provide a composite material capable of significantly reducing time and labor necessary for manufacturing composite products and of contributing to the improvement of its quality.

According to a first aspect of the present invention, a composite material comprises a dry substrate fabric sheet and a thermosetting resin thin film attached to at least one of the surfaces of the dry substrate fabric sheet as shown in FIGS. 1b and 2a.

The thermosetting resin thin film may be attached to the substrate fabric sheet with partially impregnated with the substrate fabric sheet.

Since the composite material according to the first aspect of the present invention has the thermosetting resin thin film attached to at least one of the surfaces of the dry substrate fabric sheet, i.e. the substrate fabric sheet which is not impregnated with resin previously, a composite product can be produced by forming a laminate structure by laying up a plurality of sheets of such the composite material, covering the laminated structure with a vacuum bag, evacuating air from the covered laminate structure by vacuum pump for deaeration, applying heat and pressure to the deaerated laminated structure to impregnate the substrate fabric with the thermosetting resin forming the thermosetting resin thin films and to cure the resin. Thus, a composite product can be manufactured by using the composite material according to the first aspect by a resin film infusion method (RFImethod).

When a composite product is manufactured using a conventional RFI method, the fabric sheet and the thermosetting resin thin film need to be cut respectively, and the cut fabric sheets and the cut thermosetting resin thin films need to be laminated. To the contrary, the composite material according to the first aspect of the present invention enables simultaneously cutting the dry substrate fabric sheet and the thermosetting resin thin film, and laminating sheets formed by thus cutting the composite material. Consequently, the composite material of the present invention reduces greatly time and labor for cutting and laminating in manufacturing a composite product by the RFI method.

Since the composite material according to the first aspect of the present invention has the thermosetting resin thin film attached to at least one of the surfaces of the dry substrate fabric sheet, air trapped between the sheets of the composite material during work for laying up the sheets can be easily removed through the substrate fabric sheet due to its air permeableness, which is effective in preventing the quality deterioration of the composite product.

Since the composite material according to the first aspect of the present invention has the thermosetting resin thin film attached to at least one of the surfaces of the dry substrate fabric sheet, conventional prepreg manufacturing methods including the hot-melt method and the solution method are not necessary. Therefore, there is no room for problems attributable to difficulty in completely impregnating a thick substrate fabric with a thermosetting resin and difficulty in satisfactorily volatilizing the solvent of the solution impregnated into an interior part of a thick foundation, and the functions of the composite material are not reduced and hence the quality of the composite product is not deteriorated.

In the composite material according to the second aspect of the present invention, the substrate fabric sheet may be a laminate structure formed by laying up a plurality of aligned fiber plies.

In the composite material according to the third aspect of the present invention, the substrate fabric may be a multilayer fabric of a three-dimensional weave.

Since the substrate fabric of the composite material according to the present invention is a laminate structure formed by laminating a plurality of textile layers or a multilayer fabric of a three-dimensional weave, time and labor necessary for laying up sheets of the composite material of the present invention to manufacture a composite product is far less than that necessary when a prepreg, i.e., a conventional composite material, is used for manufacturing a composite product.

In the composite material according to the fourth aspect of the present invention, a release film or a separator film may be attached to a surface of the thermosetting resin thin film, opposite to another surface of the thermosetting resin thin film covered with the substrate fabric sheet.

In other words, a thermosetting resin thin film may be attached to a dry substrate fabric sheet at a first surface of the thermosetting resin thin film, and a release film or a separator film may be attached to second surface which is a opposite surface of the first surface of the thermosetting resin thin film.

Therefore, the composite material may be wound in a roll with the releasing film wound inside or outside, which facilitates handling the composite material for transportation and storage.

### BRIEF DESCRIPTION OF THE DRAWINGS

The above and other objects, features and advantages of the present invention will become more apparent from the following description taken in connection with the accompanying drawings, in which:

FIG. 1a is a perspective view of a almost rolled up composite material in a preferred embodiment according to the present invention;

FIG. 1b is a sectional view of the composite material of FIG. 1a taken along the line 1b-1b in FIG. 1a;

FIG. 2a is a sectional view showing the composite materials laminated on a mold and covered with a vacuum bag;

FIG. 2b is a sectional view showing the laminated composite materials and the vacuum bag with its inner space being evacuated;

FIG. 3a is a sectional view showing the conventional composite materials laminated on a mold and covered with a vacuum bag; and

FIG. 3b is a sectional view showing the laminated conventional composite materials and the vacuum bag with its inner space being evacuated.

### DESCRIPTION OF THE PREFERRED EMBODIMENTS

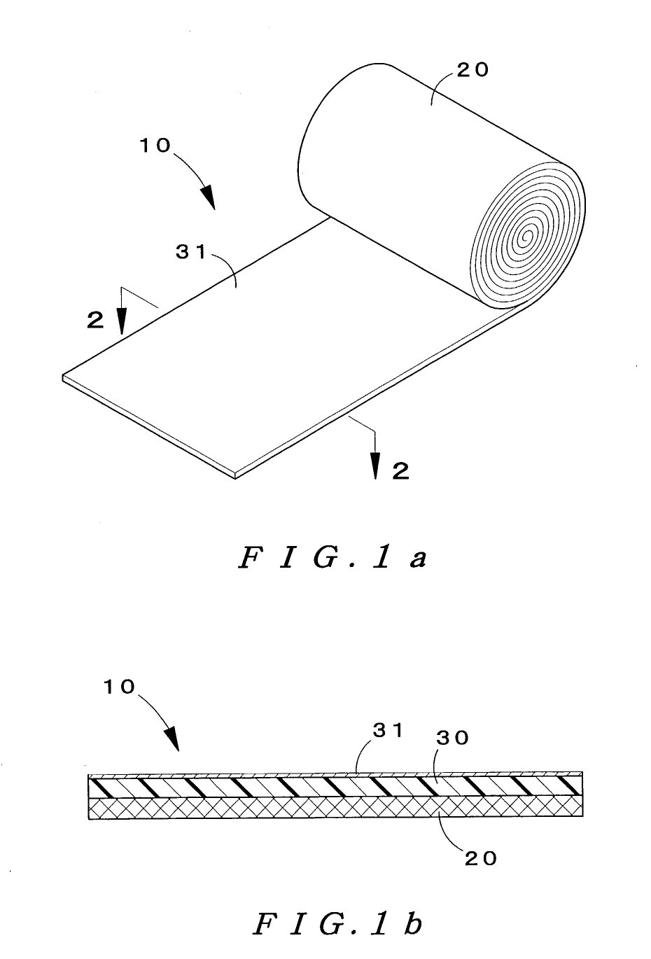

Referring to FIG. 1, a composite material 10 in a preferred embodiment according to the present invention is formed by attaching a thermosetting resin thin film 30 to a substrate fabric sheet 20. The composite material 10 can be used for manufacturing various composite products and can be used as an alternative to prepregs, i.e. conventional composite materials. The substrate fabric sheet 20 is a reinforcement that increases the strength of a composite product manufactured of the composite material 10.

The substrate fabric sheet 20 may be formed by weaving yarns of reinforcing textile material, such as glass fibers, carbon fibers, or aramid fibers (hereinafter referred to as “reinforcing fibers”). The substrate fabric sheet 20 may be woven by using yarns of different reinforcing fibers. In this embodiment, the substrate fabric sheet 20 is formed by weaving yarns of glass fibers and those of carbon fibers. The substrate fabric sheet 20 can be woven by a conventional loom, such as a multidimensional loom or a multiaxial loom.

The substrate fabric sheet 20 may be of a plane weave, a twill weave, a satin weave, a three-axis weave which arranges yarns of reinforcing fibers so as to intersect each other at an angle of 60°0 or a three-dimensional weave which arranges yarns of reinforcing fibers three-dimensionally, i.e. arranges the yarns so as to extend along three perpendicularly intersecting axes.

In this specification, the term “substrate fabric sheet” signifies a single fabric of the aforesaid weave, a multilayer fabric of the aforesaid structure or a laminate structure formed by laying up a plurality of fiber sheets each formed by unidirectionally arranging fibers, and stitching the laid-up fiber sheets.

Preferably, the substrate fabric sheet 20 is comparatively thick in order that the substrate fabric sheet 20 has a desired strength and that the number of the sheets of the substrate fabric sheet 20 necessary for forming a laminated structure having a desired strength can be reduced. For example, it is preferable that the weight per unit area of the substrate fabric sheet 20 is in the range of 400 to 1600 g/m². The weight per unit area of the substrate fabric sheet 20 in this embodiment is 600 g/m². The substrate fabric sheet 20 can be formed in a comparatively big thickness by laying up a plurality of fabrics or a plurality of fiber sheets each formed by arranging fibers parallel with each other, and stitching together the laid-up fabrics or the laid-up fiber sheets or by using a three-dimensional fabric formed by three-dimensionally arranging reinforcing fibers in parallel to three perpendicularly intersecting axes.

The substrate fabric sheet 20 of 600 g/m² in weight per unit area in this embodiment is formed by laying up four fiber sheets of 150 g/m² in weight per unit area each formed by unidirectionally arranging carbon fibers such that the unidirectionally arranged carbon fibers of the four fiber sheets extend in directions extending at angular intervals of 45°. The thickness of the substrate fabric sheet 20 thus formed is equal to that of a laminated structure formed by laying up three ordinary prepregs each formed by impregnating a bi-directional fabric with a matrix resin, and having a weight per unit area of 200 g/m² and a resin content of 40% by weight.

The thermosetting resin thin film 30 is formed of a thermosetting matrix resin that melts under heat and pressure and permeates a fabric and cures in the fabric. Thermosetting resins suitable for forming the thermosetting resin thin film 30 include epoxy resins, urea resins, melamine resins, unsaturated polyester resins, phenolic resins, crosslinked polyethylene resins, bismaleimide resins and polyimide resins. The thermosetting resin thin film 30 of this embodiment is formed of an epoxy resin.

The epoxy resin forming the thermosetting resin thin film 30 has a tackiness of a level high enough to hold the thermosetting resin film 30 temporarily on the substrate fabric sheet 20. Therefore, the thermosetting resin thin film 30 can be attached to the substrate fabric sheet 20 without using any adhesive or any adhesive double-coated tape. The thickness of the thermosetting resin thin film 30 is determined properly, taking into consideration the thickness, the type of component fibers and the weave of the substrate fabric sheet 20. The thickness of the thermosetting resin thin film 30 of this embodiment is about 0.3 mm. The thermosetting resin thin film 30 can be formed by a conventional knife coater or roller coater.

A procedure for manufacturing a composite product from the composite material 10 of this embodiment by the RFI method is now described below.

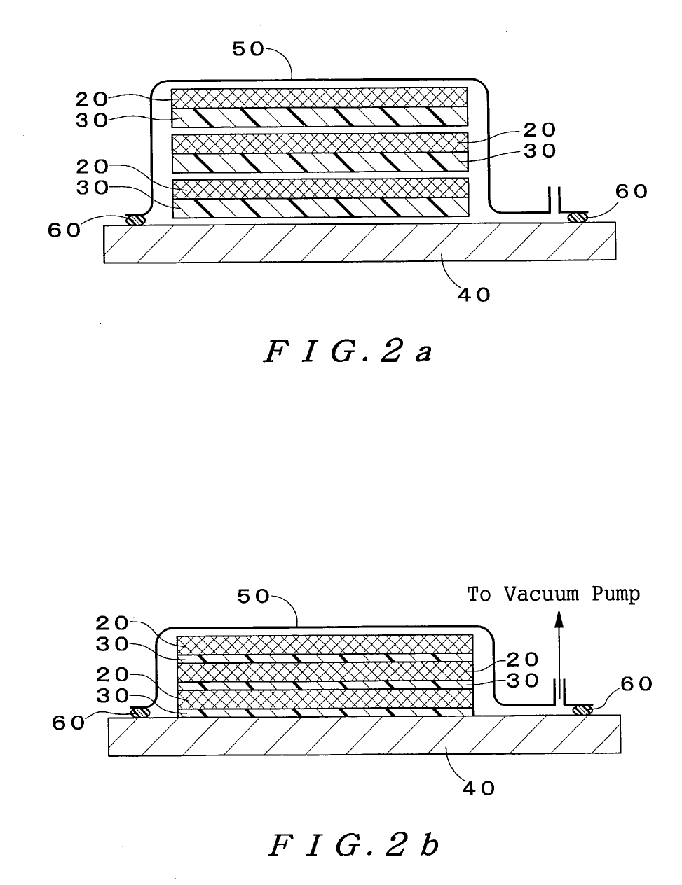

The composite material 10 is cut into a plurality of sheets of a predetermined shape. A predetermined number of the sheets of the composite material 10 are laid up in a laminated structure on a desired mold 40. In this embodiment, as shown in FIG. 2a, the thermosetting resin thin films 30 are placed on the lower side, i.e., on the side of the mold 40.

Then, the laminated structure of the sheets of the composite material 10 is covered with a vacuum bag 50. The joint of the tool 40 and the vacuum bag 50 is sealed by a bag sealant tape 60 as shown in FIG. 2a. Then, a inner space of the vacuum bag 50 is evacuated by a vacuum pump as shown in FIG. 2b. Then, pressure and heat are applied to the laminated structure of the sheets of the composite material 10 in an oven or the like. Consequently, the thermosetting resin films 30 melt in a molten thermosetting resin, the molten thermosetting resin permeates the substrate fabrics 20, and the thermosetting resin cures in the substrate fabrics 20. Thus, a desired composite product can be manufactured from the composite material 10 in this embodiment.

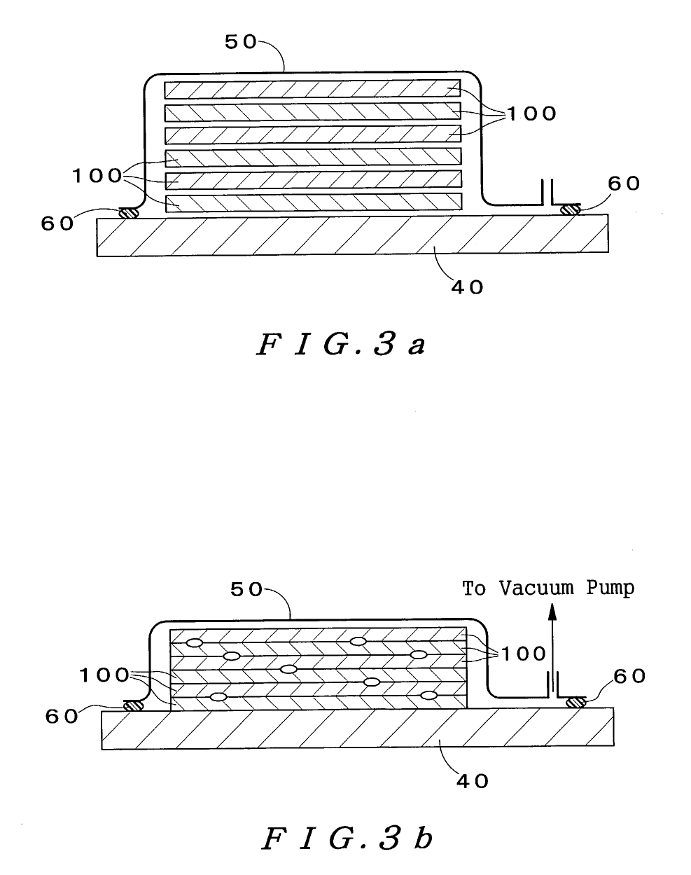

When a plurality of prepregs 100, i.e. a conventional composite material, is laid up in a laminated structure, the laminated structure is covered with a vacuum bag 50 as shown in FIG. 3a. And the inner space of the vacuum bag 50 is evacuated by a vacuum pump as shown in FIG. 3b. In some cases, air between the layers of the prepregs 100 cannot be extracted and remains between the layers of the prepregs 100 as shown in FIG. 3b. Pressure must be applied to the laminated structure of the prepregs 100 by an autoclave or the like to remove the air remaining between the layers of the prepregs 100.

To the contrary, since the composite material 10 of the present invention has the thermosetting resin thin film 30 attached to at least one of the surfaces of the dry substrate fabric sheet 20, air trapped between the layered sheets of the composite material 10 can be easily removed when heat and pressure are applied to the laminated structure to melt and cure the thermosetting resin thin film 30 (FIG. 2b). That is, air trapped between the layered sheets of the composite material 10 can be easily extracted through the air-permeable substrate fabrics 20 of the layered sheets. Therefore, a composite product of high quality can be manufactured by simple processes.

Since the composite material 10 of the present invention is formed by attaching the thermosetting resin thin film 30 to the dry substrate fabric sheet 20, a composite product can be produced by forming a laminated structure by laying up a plurality of sheets of the composite material 10, covering the laminate structure with the vacuum bag 50, evacuating air from the covered laminate structure by vacuum for deaeration, applying heat and pressure to the deaerated laminate structure to impregnate the substrate fabric sheet 20 with the thermosetting resin forming the thermosetting resin thin film 30 and to cure the resin. Thus, the composite product can be manufactured by using the composite material of the present invention by the RFI method.

Since the substrate fabric sheet 20 and the thermosetting resin thin film 30 can be simultaneously cut when the composite material 10 of the present invention is cut into sheets, time and labor necessary for cutting a material into sheets and laying up the sheets can be significantly reduced when the composite material 10 is used for manufacturing a composite product by the RFI method.

Since the composite material 10 of the present invention has the comparatively thick (600 g/m²), dry substrate fabric sheet 20, time and labor necessary for laying up sheets of the composite material 10 to manufacture a composite product is far less than those necessary when a prepreg, i.e., a conventional composite material, is used for manufacturing a composite product.

Since the composite material 10 of the present invention is formed by applying the thermosetting resin thin film 30 to the unimpregnated, dry substrate fabric sheet 20, conventional prepreg manufacturing methods including the hot-melt method and the solution method are not necessary. Therefore, the functions of the composite material 10 are not reduced and hence the quality of the composite product is not deteriorated.

In the composite material 10 of the present invention, a release film 31 is attached to a surface of the thermosetting resin thin film 30, which is opposite to another surface of the thermosetting resin thin film 30 covered with the substrate fabric sheet 20. Therefore, the composite material 10 can be wound in a roll with the releasing film rolled inside as shown in FIG. 1 or rolled outside (not shown), and the roll of the composite material 10 can be transported and stored, which facilitates handling the composite material 10 for transportation and storage. When the composite material 10 is cut into sheets of a desired shape, the sheets can be laid up in stacks with the sheets separated from each other by the release film, and the stacks of the sheets of the composite material 10 can be transported and stored.

Furthermore, in the composite material 10 of this invention, the thermosetting resin thin film 30 is attached to the substrate fabric sheet 20 with partially impregnated with the substrate fabric sheet 20.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

This application is based on the Japanese Patent Application No. 366742/2001 filed on Nov. 30, 2001, the content of which is herein incorporated by reference.

What is claimed is:

1. A composite material comprising:
a dry substrate fabric sheet; and
a thermosetting resin thin film attached to at least one of surfaces of the dry substrate fabric sheet.

2. The composite material according to claim 1, wherein
the substrate fabric sheet is a laminate structure formed by laying up a plurality of aligned fiber plies.

3. The composite material according to claim 1, wherein
the substrate fabric sheet is a multiplayer fabric of a three-dimensional weave.

4. The composite material according to claim 3, wherein
the release film is attached to a surface of the thermosetting resin thin film opposite to another surface of the thermosetting thin film covered with the substrate fabric sheet.

5. The composite material according to claim 4, wherein the composite material is wound in a roll.

6. The composite material according to claim 1, wherein
the thermosetting resin thin film is attached to the substrate fabric sheet with partially impregnated with the substrate fabric sheet.

7. A composite material comprising:
a dry substrate fabric sheet;
a thermosetting resin thin film attached to the dry substrate fabric sheet at a first surface of the thermosetting resin thin film; and
a release film attached to second surface of the thermosetting resin thin film, the second surface being opposite surface of the first surface of the thermosetting resin thin film.

8. The composite material according to claim 7, wherein the composite material is wound in a roll.
